(19) United States
(12) Patent Application Publication
(10) Pub. No.: US 2007/0068406 A1
(43) Pub. Date: Mar. 29, 2007

(54) Printing unit for a press

(75) Inventors: Thomas Hartmann, Mering (DE); Godber Petersen, Augsburg (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG

(21) Appl. No.: 11/510,421

(22) Filed: Aug. 25, 2006

(30) Foreign Application Priority Data
Aug. 27, 2005 (DE) 10 2005 040 614.9

(51) Int. Cl. B41F 5/00

(52) U.S. Cl. 101/216

(57) ABSTRACT

A printing unit for a web-fed rotary press includes a forme cylinder which receives at least one printing forme, an inking unit applying printing ink to the at least one printing forme on the forme cylinder, and a damping unit, if required, applying a damping solution to the at least one printing forme on the forme cylinder. The inking unit has inking unit rolls including ink applicator rolls and distributor rolls. The damping unit, if required, has damping unit rolls including a damping solution applicator roll and a distributor roll: When a format change is carried out adapting the inking unit and, if appropriate, the damping unit to a changing diameter of the forme cylinder, at least some of the inking unit rolls and, if appropriate, some of the damping unit rolls are displaced automatically while maintaining the contacts and while maintaining approximately constant line forces between inking unit rolls rolling on one another and, if appropriate, damping unit rolls rolling on one another.

### BACKGROUND OF THE INVENTION

1. Field of the Invention

The invention relates to a printing unit for a press having a forme cylinder receiving a printing forme, an inking unit for applying printing ink to the printing formes on the forme cylinder, and a damping unit, if required, for applying damping solution to the printing forme, each of the inking unit and damping unit having applicator rolls and distributor rolls.

2. Background of the Invention

Printing units of presses have a forme cylinder, on which at least one printing forme is positioned. In addition to the forme cylinder, printing units also have an inking unit and, if appropriate, a damping unit, with the aid of the inking unit printing ink being applied to the or each printing forme positioned on the forme cylinder. With the aid of the damping unit, damping solution is applied to the or each printing forme positioned on the forme cylinder. Starting from the forme cylinder, the printing ink is transferred to a transfer cylinder or rubber-covered cylinder, which ultimately applies the printing ink to a printing material. The transfer cylinder or rubber-covered cylinder in this case rolls either on an impression cylinder or on a rubber-covered cylinder of an adjacent printing unit.

In variable-format printing units it is necessary to adapt the individual subassemblies to different printing formats. To this end, in particular the inking unit and the damping unit have to be adapted to changing diameters of the forme cylinders. It is already known from practice to adapt what are known as ink applicator rolls of an inking unit of a printing unit to different-sized diameters of the forme cylinders by the ink applicator rolls being pivoted. In this case, during what is known as setting the inking unit onto the forme cylinder, the ink applicator rolls are firstly pivoted away from the forme cylinder in order then to be pivoted onto the forme cylinder again when the inking unit has reached its position. In this case, the intention is to achieve pre-inking of the inking unit and also the forme cylinder, in order to reduce what is known as start-up rejects at the start of the actual printing process. All of the rolls of the inking unit and of the damping unit have to be in contact with one another during this start-up process, what are known as the line forces between the rolls having to remain the same in order that the inking process is not interrupted. As a result of component tolerances and friction, this setting up phase of the inking unit with the simultaneous pre-inking of the same can be implemented in practice only with a great deal of effort; in particular a complicated and expensive configuration of the inking unit is required for this purpose.

### SUMMARY OF THE INVENTION

An object of the present invention is to provide a novel type of printing unit for a press. This object is achieved by a printing unit for a press having a forme cylinder receiving a printing forme, an inking unit for applying printing ink to the printing formes on the forme cylinder, and a damping unit, if required, for applying damping solution to the printing forme. The inking unit includes inking unit rolls including ink applicator rolls and distributor rolls and the damping unit, if required, has damping solution applicator rolls and distributor rolls. According to the invention, when carrying out a format change, specifically when adapting the inking unit and, if appropriate, the damping unit to a changing diameter of the forme cylinder, at least some of the inking unit rolls and, if appropriate, some of the damping unit rolls can be displaced automatically while maintaining the contacts and while maintaining approximately constant line forces between inking unit rolls rolling on one another and, if appropriate, damping unit rolls rolling on one another.

With the present invention, a simple, cost-effective and compact printing unit is proposed in which the inking unit can be adapted to different diameters of the forme cylinder with good pre-inking when carrying out a format change.

According to one embodiment of the present invention, the displaceable inking unit rolls and the displaceable damping unit rolls are assigned a plurality of pneumatic pistons. For each of the displaceable rolls, the plurality of pneumatic pistons includes pneumatic pistons for absorbing the weight of the respective roll and pneumatic pistons for providing a defined line force between the respective roll and the rolls rolling on the same or the forme cylinder rolling on the same.

The quantity of the pneumatic air supplied to the pneumatic pistons can be set in such a way that the pneumatic air produces a constant force on the respective pneumatic piston over the entire stroke of the same, and that the respective pneumatic piston is mounted in the manner of an air pad and therefore virtually without friction.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Preferred developments of the invention emerge from the subclaims and the following description. An exemplary embodiment of the invention, without being restricted thereto will be explained in more detail by using the drawing, in which:

FIG. 1 is a schematic side view of a printing unit of a press in the region of an inking unit, a damping unit and a forme cylinder according to the present invention;

FIG. 2 is an enlarged view of a detail of the printing unit of FIG. 1 in the region of a damping solution applicator roll;

FIG. 3 is a further enlarged detail of the printing unit of FIG. 1 in the region of the damping solution applicator roll;

FIG. 4 is a partial sectional view of the damping solution applicator roll and of a mounting of the same in the direction IV according to FIG. 2;

FIG. 5 is a detailed view of the arrangement of FIG. 4 in the direction V in FIG. 4;

FIG. 6 is a cross sectional view through the arrangement of FIG. 4 along the section line VI-VI in FIG. 4;

FIG. 7 is a cross sectional view through the arrangement of FIG. 4 along the section line VII-VII in FIG. 4;

FIG. 8 is a cross sectional view through the arrangement of FIG. 4 along the section line VIII-VIII in FIG. 4;

FIG. 9 is a partial sectional view of a mounting of an intermediate roll of the inking unit of the printing unit according to the invention;

FIG. 10 is an enlarged view of a detail of the mounting according to FIG. 9;

FIG. 11 is a view of a detail of the arrangement of FIG. 10 in the direction XI in FIG. 10;

FIG. 12 is a cross sectional view through the arrangement of FIG. 10 along the section line XII-XII in FIG. 10;

FIG. 13 is a cross sectional view through the arrangement of FIG. 10 along the section line XIII-XIII in FIG. 10;

FIG. 14 is a cross sectional view through the arrangement of FIG. 10 along the section line XIV-XIV in FIG. 10;

FIG. 15 is a cross sectional view through the arrangement of FIG. 10 along the section line XV-XV in FIG. 10;

FIG. 16 is a partial sectional side view of a detail of the printing unit according to the invention, inking unit rolls of the inking unit being shown in an inking position;

FIG. 17 is a partial sectional side view of the detail of FIG. 16 in the pre-damping position of the forme cylinder;

FIG. 18 is a partial sectional side view of the detail of FIG. 16 in the inking position of the forme cylinder in small format;

FIG. 19 is a partial sectional side view of the detail of FIG. 16 in the inking position of the forme cylinder in large format;

FIG. 20 is a partial sectional side view of the detail of FIG. 16 with the rolls thrown off;

FIGS. 21 to 24 are schematic side views of the printing unit, each showing a different step in a sequence of setting positions of the printing unit;

FIG. 25 is a cross sectional view through a distributor roll of the inking unit of the printing unit according to the invention;

FIG. 26 is a schematic side view of the printing unit showing a drive of the distributor rolls via a crankshaft;

FIG. 27 is a schematic side view showing an alternative drive of the distributor rolls;

FIG. 28 is a sectional view of a detail of the arrangement according to FIG. 27;

FIG. 29 is a schematic side view showing an alternative drive of the distributor rolls with epicyclic gear mechanisms;

FIG. 30 is a sectional view of one of the epicyclic gear mechanisms of FIG. 29;

FIG. 31 is an enlarged view of a detail of the arrangement of FIG. 29 in the direction XXXI in FIG. 29;

FIG. 32 is a schematic side view of a drive of the distributor rolls via individual drives;

FIG. 33 is a cross sectional view through the arrangement of FIG. 32 along the section line XXXIII-XXXIII of FIG. 32;

FIG. 34 is a schematic side view of a drive of the distributor rolls via individual linear motor drives;

FIG. 35 is a cross sectional view through the arrangement of FIG. 34 along the section line XXXV-XXXV in FIG. 34; and

FIG. 36 is a schematic representation of a press control system in which the press unit according to the present invention is implemented.

### DETAILED DESCRIPTION OF THE PRESENTLY PREFERRED EMBODIMENTS

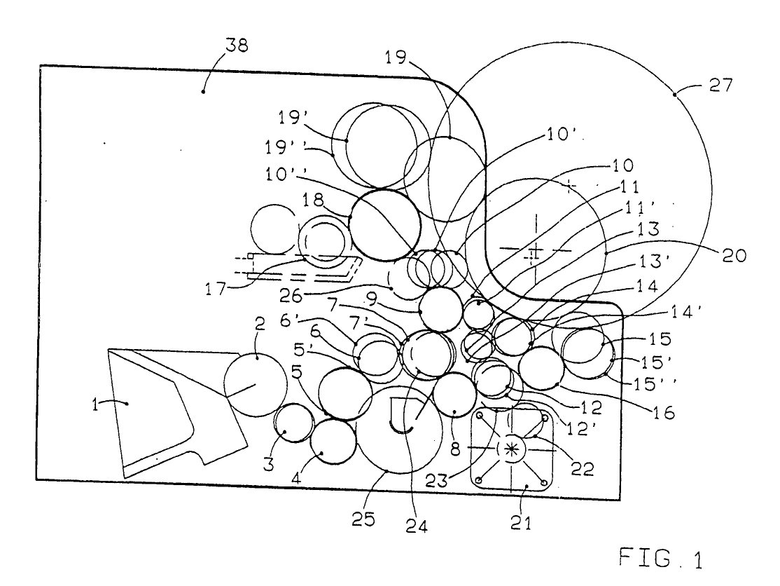

FIG. 1 shows an extract from a printing unit of a press in the region of an inking unit, a damping unit and a forme cylinder. Of the inking unit of the printing unit, an ink fountain 1 is shown, in which printing ink is kept ready. The printing ink kept ready in the ink fountain 1 is removed from the ink fountain 1 by an ink ductor roll 2 and, starting from the ink ductor roll 2, is transferred via an ink feed roll 3 to a distributor roll 4 of the inking unit. Via inking unit rolls 5, 6 and 7 arranged downstream of the ink distributor roll 4, the printing ink reaches distributor rolls 8 and 9, the printing ink on the inking unit roll 7 being divided up between the distributor rolls 8 and 9. Starting from the distributor roll 9, the printing ink branches to what are known as ink applicator rolls 10 and 11; starting from the distributor roll 8, on the other hand, the printing ink is distributed by inking unit rolls 12 and 13 to ink applicator rolls 11, 14 and 15. A further distributor roll 16 rolls on the ink applicator rolls 14 and 15. The ink applicator rolls 10, 11, 14 and 15 roll on a forme cylinder or at least one printing forme positioned on the forme cylinder.

Of the damping unit, a damping solution container not numbered in FIG. 1 is illustrated, damping solution kept ready in the damping solution container being removed from the damping solution container via a damping solution ductor roll 17 and applied to a damping solution distributor roll 18. From the damping solution distributor roll 18, the damping solution reaches the forme cylinder 20 or the or each printing forme positioned on the forme cylinder 20, via a damping solution applicator roll 19.

The distributor rolls 4, 8, 9, 16 and 18 of the inking unit and damping unit are mounted in side walls 38 of the inking unit such that they cannot be displaced and are driven by a drive 21 via fixed-location spur gears 22, 23, 24, 25 and 26. The rolls 5, 6, 7, 12 and 13 of the inking unit can be displaced in their position and, during printing, in order to transfer printing ink onto the or each printing forme positioned on the forme cylinder 20, assume the position and location shown in FIG. 1. In what is known as a thrown-off position, the same are in the positions and locations identified by the reference numbers 5′, 6′, 7′, 12′ and 13′, in which the same do not touch any inking unit roll or any distributor roll.

In FIG. 1, the forme cylinder 20 corresponds to a forme cylinder in what is known as small format; a forme cylinder 27 in large format is also illustrated in FIG. 1. In the case of both forme cylinders 20 and 27 and accordingly in the case of both printing formats, the ink applicator rolls 11 and 14, which can likewise be displaced, assume approximately the same location or position; in the thrown-off position 11′ and 14′, the same do not touch any distributor roll or any inking unit roll. The ink applicator rolls 10 and 15 and the damping solution applicator roll 19 assume the positions identified by the reference numbers 10′, 15′ and 19′ with respect to the large-format forme cylinder 27. The thrown-off positions of these applicator rolls are identified by the reference numbers 10″, 15″ and 19″. In the thrown-off position, the ink applicator rolls 10 and 15 and the damping solution applicator roll 19 do not touch any distributor roll or any other roll of inking unit or damping unit.

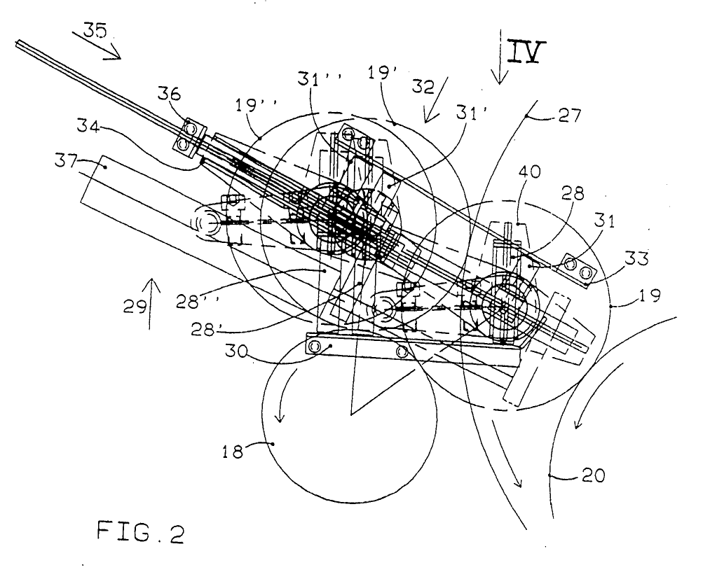

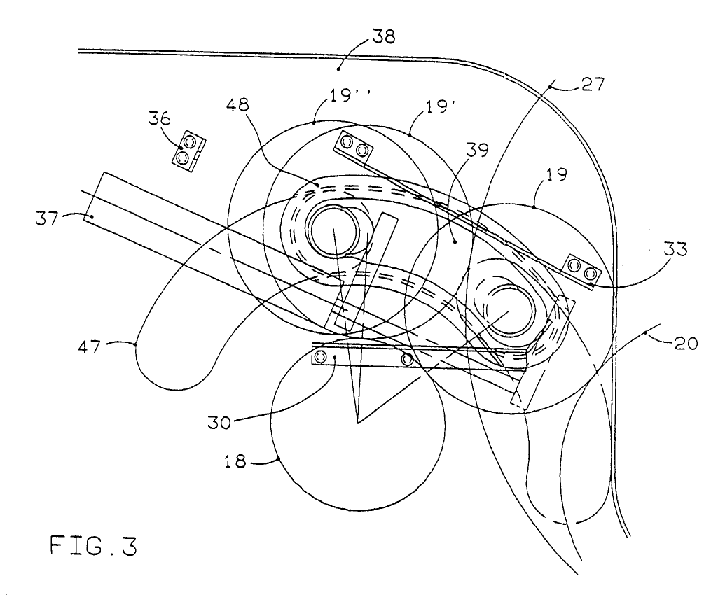

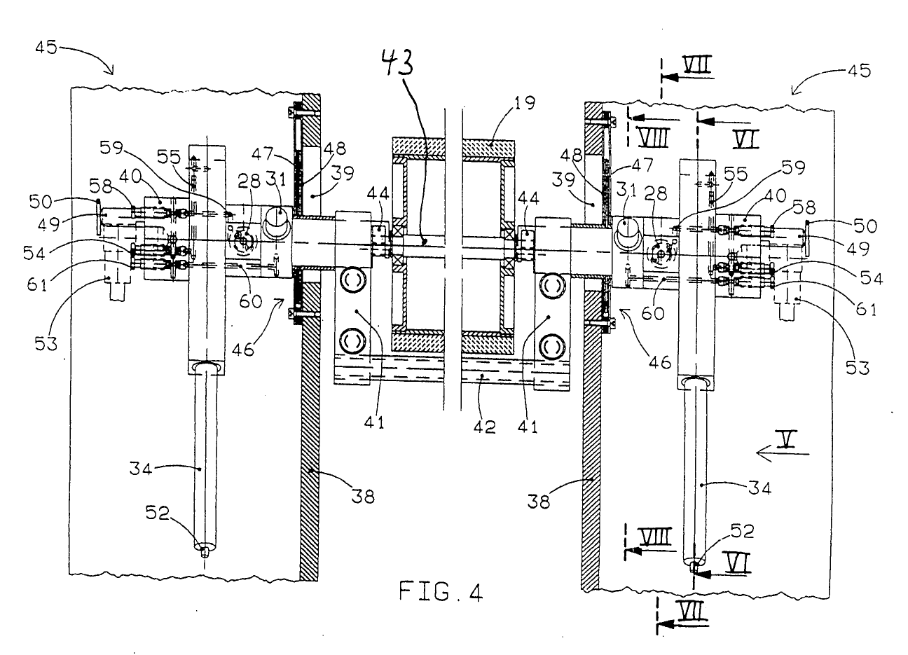

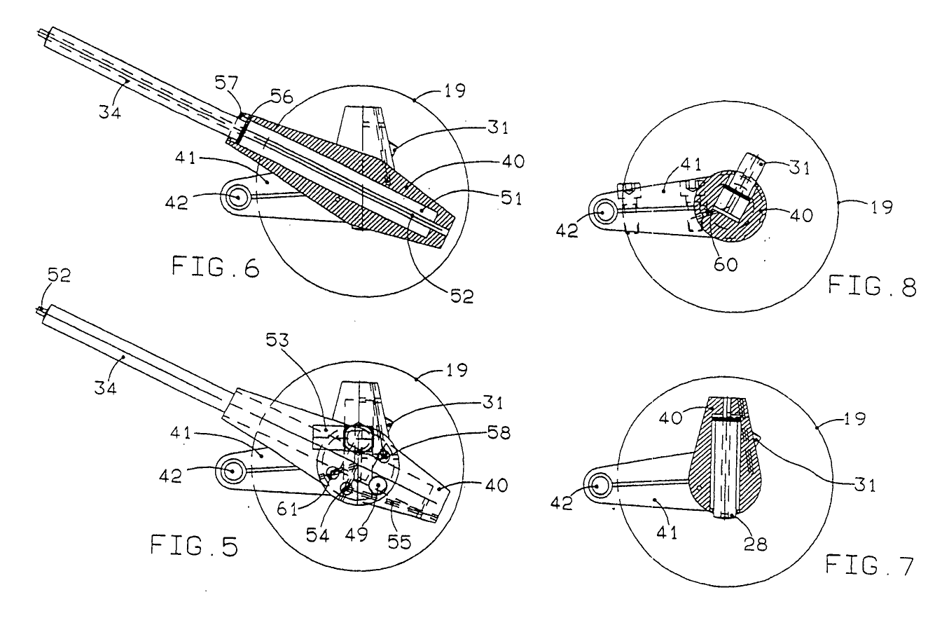

FIGS. 2 and 3 show enlarged details of the printing unit of FIG. 1 in the region of the damping solution applicator roll 19. FIG. 4 shows the damping solution applicator roll 19 in the viewing direction IV of FIG. 2. FIGS. 5 to 8 show various sectional illustrations through a mounting of the damping solution applicator roll 19.

As can be gathered in particular from FIG. 2, the weight of the damping solution applicator roll 19 in all the positions 19, 19′ and 19″ of the same is absorbed by pneumatic pistons 28. The pneumatic pistons 28 run in the direction of the direction arrow 29. The various positions of the pneumatic pistons 28 are identified in FIG. 2 by the reference numbers 28, 28′ and 28″. The pneumatic pistons 28 are supported on a holding element 30 in each of their positions and are set via a supply of air in such a way that the weight of the damping solution applicator roll 19 is just compensated for. Further pneumatic pistons 31 are set such that the damping solution applicator roll 19 is forced in the direction of the direction arrow 32 against the distributor roll 18 with a defined line force, the pneumatic pistons 31 again being supported on a holding element 33 in all the positions identified by the reference numbers 31, 31′ and 31″. Further pneumatic pistons 34, finally, force the damping solution applicator roll 19 with an adjustable line force in the direction of the direction arrow 35 onto the forme cylinder 20 or the forme cylinder 27, the pneumatic pistons 34 being supported on a holding element 36. Using a pneumatic cylinder 37 and with the pneumatic pistons 29, 31 and 34 deactivated, the damping solution applicator roll 19 can be brought into a defined thrown-off position 19″, in which the same touches neither the forme cylinder 20 or 27 nor the distributor roll 18. As can be gathered from FIG. 3, a slot 39 running in an arc, within which the damping solution applicator roll 19 is guided, is integrated into the side walls 38 of the inking unit.

FIG. 4 shows the mounting of the damping solution applicator roll 19, which is designed symmetrically on both sides. FIGS. 5 to 8 show various details of this mounting.

Bearing housings 40 are joined to each other via clamping piece 41 and a tube 42. An axle 43 of the damping solution applicator roll 19 is mounted in the bearing housings 40 and is in each case clamped firmly by a clamp 44 such that the damping solution applicator roll 19 can be installed and removed without a special tool. Mountings are located in a protected manner within housings 45 and are sealed off from the outside without friction via labyrinth seals 46. The labyrinth seals 46 ensure the full freedom of movement of the damping solution applicator roll 19. The labyrinth seals 46 comprise inner and outer sheet-metal segments 47 and 48. The lateral guidance of the damping solution applicator roll 19 is performed by spacers 49 screwed into the bearing housing 40 and supported on holding elements 50.

In the sectional illustration according to FIG. 6 along the section line III-III of FIG. 4, the guidance of the pneumatic piston 34 within the bearing housing 40 is shown. The pneumatic piston 34 moves on the outside within a cylindrical bore 51 and is mounted on a rod 52 which is fixed in the bearing housing 40. The rod 52 secures the bearing housing 40 against rotation about an axis of the same and is pushed through a hole in the holding element 36.

As shown in FIGS. 4 and 5, pneumatic air is provided centrally at a connection 53 and is supplied to the individual pneumatic pistons via restrictors and ducts. The quantity of air supplied to the pneumatic piston 34 is set at a restrictor 54 and is supplied via a duct 55 to the cylindrical bore 51. In accordance with the air pad principle, as it is known, the pneumatic air flows continuously past the piston 34 via a labyrinth seal 56. In this way, once set, a constant force on the pneumatic piston 34 is provided over the entire stroke of the same. A securing ring 57 secures the pneumatic piston 34 against sliding out. By means of the pneumatic air flowing in the labyrinth seal 56 and, to a small extent also between the rod 52 and the pneumatic piston 34, the same slides virtually without friction. In this way, the force acting on the pneumatic piston 34 can be set very accurately at the restrictor 54; furthermore, the same remains approximately constant over the entire movement distance of the pneumatic piston 34. As a result, the line forces on the damping solution applicator roll 19 can also be set accurately and they remain approximately constant during all the movements of the rolls of the damping unit, since they are aimed in the direction of these lines of contact. This air pad principle is applied in all the moving rolls of the printing unit and therefore in all the displaceable rolls of the inking unit and damping unit. Thus, all the rolls can be displaced with constant contact forces.

According to FIG. 4, the pneumatic pistons 28, 31 and 34 always act in pairs on each bearing side of the damping solution applicator roll 19. The pair of pneumatic pistons 34 forces the damping solution applicator roll 19 onto the forme cylinder 20 or 27 in the direction of the direction arrow 35. The pair of pneumatic pistons 28 (see FIG. 7) is set via restrictors 58 (see FIGS. 4 and 5). The pneumatic pistons 28 compensate for the weight of the damping solution applicator roll 19. The pneumatic air is supplied via ducts 59. Pneumatic air is supplied to the pair of pneumatic pistons 31 via ducts 60, it being possible for the appropriate quantity to be set at a restrictor 61 (see FIGS. 5 and 8). The pneumatic pistons 31 force the damping solution applicator roll 19 onto the distributor roll 18 with a defined line force in the direction of the direction arrow 32 (see FIG. 2).

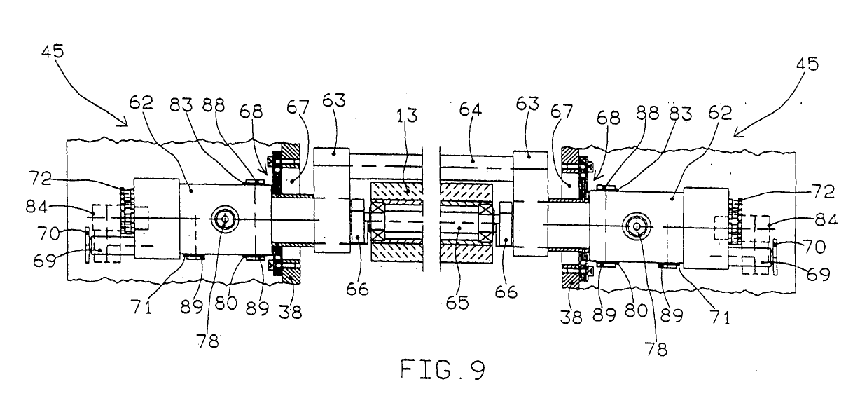

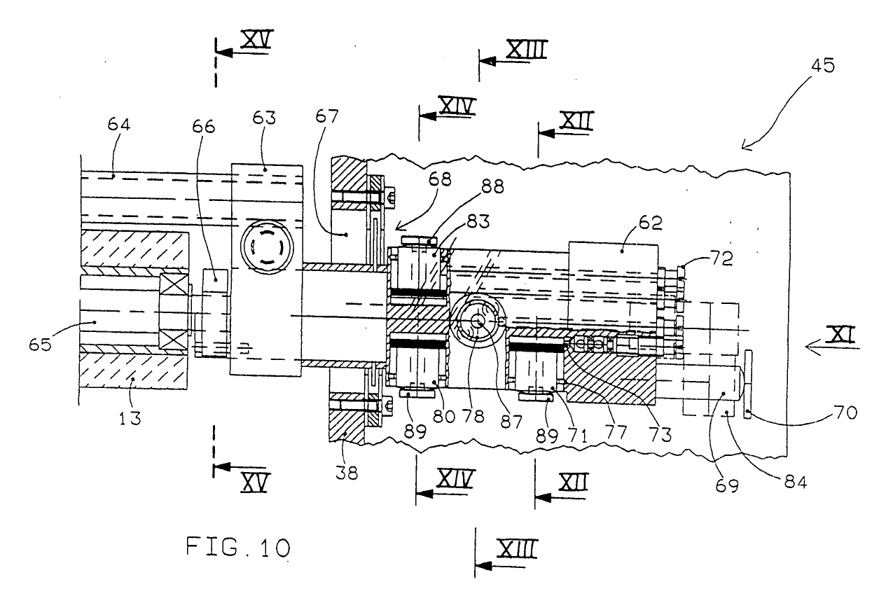

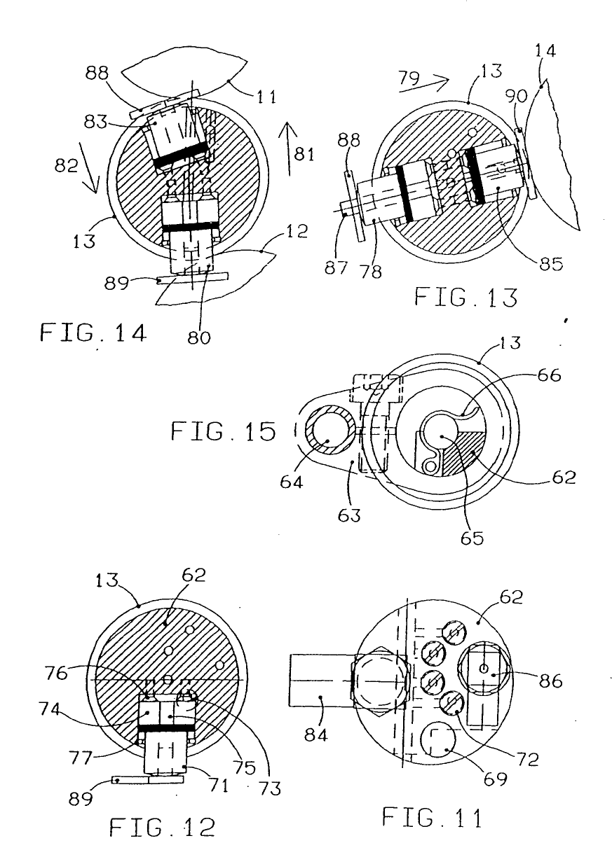

FIGS. 9 to 15 show the mounting of a movable or displaceable ink applicator roll by using the example of the inking unit roll 13. The mounting is designed for three force directions, weight compensation and a thrown-off movement. The structure of the mounting resembles the structure of the mounting for the damping solution applicator roll 19. Bearing housings 62 are joined to each other via clamping pieces 63 and a tube 64. The inking unit roll 13 lies with an axle 65 in the manner of a half shell on both sides in the bearing housings 62 (see FIG. 15) and is fixed via clamps 66. In the region of the side walls 38 of the inking unit, the bearing housings 62 are guided such that they can move freely through slots 67, the slots 67 being sealed off via labyrinth seals 68. The mounting of the inking unit roll 13 is guided laterally via pins 69 on the holding elements 70. As shown in FIG. 12, the weight force of the inking unit roll 13 is compensated for via pneumatic pistons 71, which are again present in pairs. The supply of pneumatic air is set via restrictors 72 and is supplied via bores 73 to a cylindrical space 74. The pneumatic pistons 71 are mounted on pin plates 75, which are fixed in the bearing housing 62 by countersunk screws 76. A securing ring 77 prevents the pneumatic pistons 71 from sliding out.

As shown in FIGS. 13 and 14, pneumatic pistons 78, which are again present in pairs, force the damping solution applicator roll 19 onto the ink applicator roll 14 in the direction of the direction arrow 79, while pneumatic pistons 80, which are likewise present in pairs, force the inking unit roll 13 against the ink applicator roll 11 in the direction of the direction arrow 81. The inking unit roll 13 is forced against the inking unit roll 12 in the direction of the direction arrow 82 by pneumatic pistons 83, which are also present in pairs. The structure of the pneumatic pistons 78, 80 and 83 present in pairs corresponds to the structure of the pneumatic pistons 71, so that reference here is made to the explanations in this respect in order to avoid unnecessary repetitions.

The supply of air to the pneumatic pistons is carried out via central connections 84. The supply of air can be set separately via the restrictors 72 for each pair of pneumatic pistons and is supplied to the same via ducts. Pneumatic pistons 85 are used to throw off the inking unit roll 13 into the position shown in FIG. 1 by reference number 13′. Here, pneumatic air is supplied separately via a connection 86. For the throwing-off movement, the air supply is regulated and switched centrally on the inking unit. The pneumatic pistons 78 perform the securing of the mounting of the inking unit roll 13 against rotation via pin plates 87, by the latter being pushed through a hole in a holder 88.

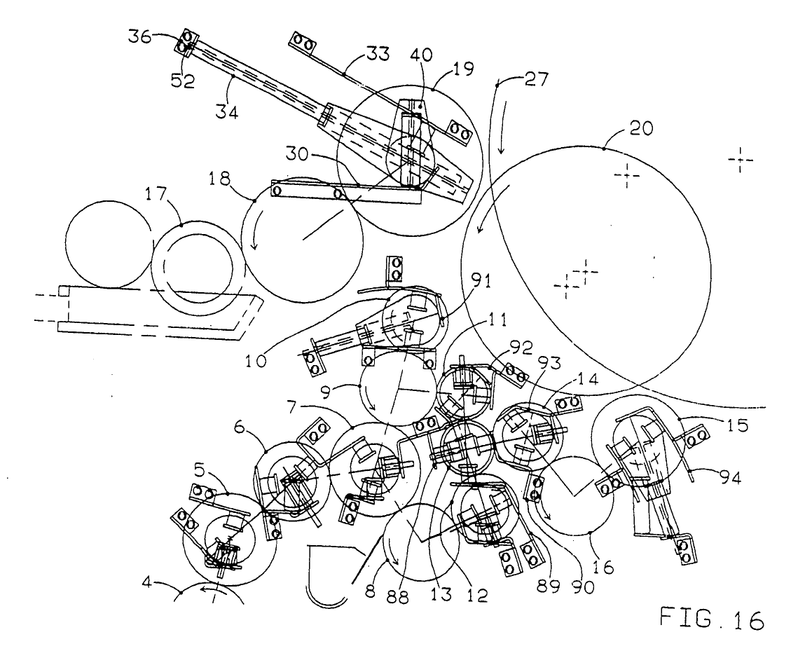

FIG. 16 illustrates schematically how the pneumatic pistons of the mounting of the inking unit roll 13 are supported on holding elements, which are in turn fixed to the side walls 38 of the inking unit. For the inking unit roll 13, these are the holding elements 88, 89 and 90 shown.

With reference to FIGS. 1 to 15, the mounting of the displaceable rolls has been explained above by way of example by using the example of the inking unit roll 13 and the damping solution applicator roll 19. The mountings of the other movable or displaceable rolls of the inking unit are constructed similarly, so that reference is made to the above explanations.

In the above exemplary embodiments, the pneumatic air for the pressing force of the rolls among one another and for the compensation of the weight was combined, regulated and switched centrally on the inking unit. If pressing forces are to be capable of being varied centrally, then it must be possible for the pneumatic air to compensate for the weight to be supplied centrally and separately, since it is set only once and then no longer varied.

The mountings described above of the rolls permit operationally secure, virtually wear-free operation of the printing unit, specifically the inking unit and the damping unit of the printing unit. Swelling or shrinkage of the roll covers does not effect any change in the forces between the rolls; instead the rolls compensate for these diameter changes automatically, which means that destruction of the roll covers and therefore failure of the printing unit, specifically of the inking unit and the damping unit, is avoided. The expenditure on maintenance and setting is reduced substantially, since the rolls can easily be removed and set themselves automatically.

In the following text, with reference to FIGS. 16 to 20, various settings of the printing unit according to the invention will be shown, which range from the operating state of pre-inking, as it is known, via printing operation as far as throwing off the rolls of the inking unit and damping unit. In the setting of the printing unit according to FIG. 16, the state of pre-inking the inking unit rolls and pre-damping the damping unit rolls is shown. Neither the ink applicator rolls 10, 11, 14 and 15 nor the damping solution applicator roll 19 touches the press cylinder 20 or 27. Firstly, all the inking unit rolls and, secondly, all the damping unit rolls are thrown onto one another via the supply of pneumatic air, so that their line forces can be set uniformly to a preset value. The weights of the rolls are compensated for. The bearing housing of the damping solution applicator roll 19 rests on the holding element 30, the corresponding bearing housings of the ink applicator rolls 10, 11, 14 and 15 rest on the holding elements 91, 92, 93 and 94.

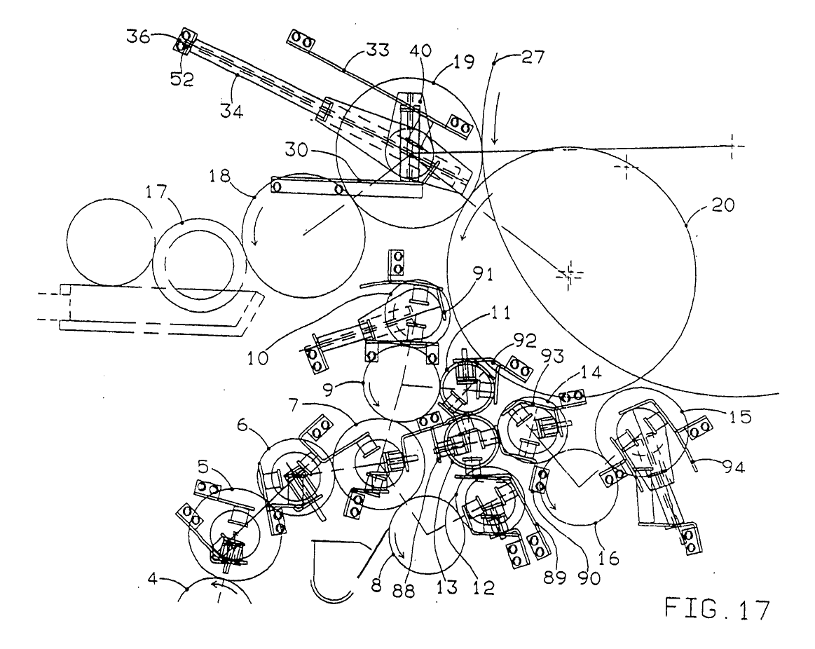

FIG. 17 shows the operating state of pre-damping the press cylinder 20 or the or each printing forme positioned on the press cylinder 20. In this case, damping unit and inking unit have been brought into a position with respect to the forme cylinder 20 or 27 in which only the damping solution applicator roll 19 rolls on the press cylinder 20 or 27. The ink applicator rolls 10, 11, 14 and 15 of the inking unit are by contrast thrown off the forme cylinder 20 or 27. The damping solution applicator roll 19 with its bearing housing 40 retreats from contact with the holding element 30. The contact with the distributor roll 18 is maintained by the set force. The force with which the damping solution applicator roll 19 touches the forme cylinder 20 or 27 corresponds to the set line force. The ink applicator rolls 10, 11, 14 and 15 continue to rest with their bearing housings on their holding elements 91, 92, 93 and 94 and do not touch the forme cylinder 20 or 27.

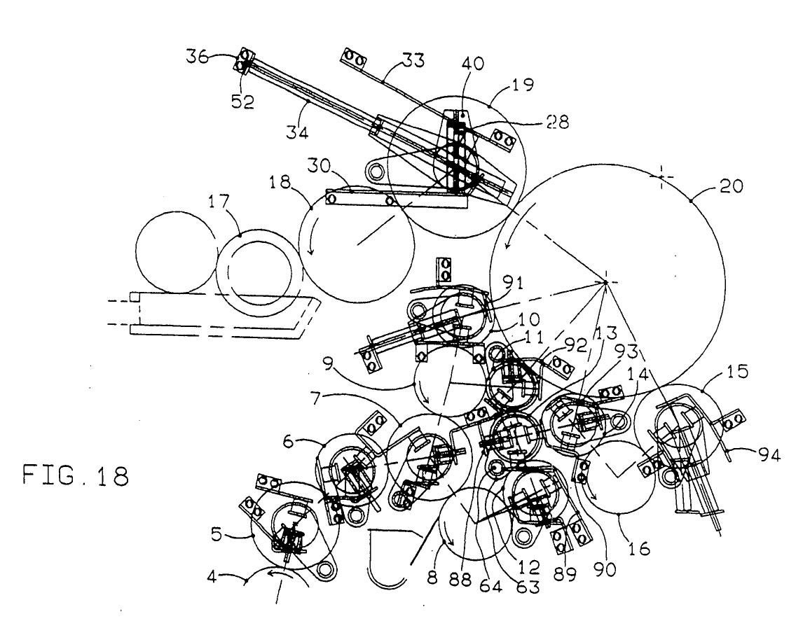

FIG. 18 shows the state of the printing unit during printing or pre-inking a small printing format, in this case both the damping solution applicator roll 19 and the ink applicator rolls 10, 11, 14 and 15 resting on the small-format press cylinder 20. In this state, accordingly, firstly printing ink and secondly damping solution is applied to the or each printing forme positioned on the forme cylinder 20. All the rolls of inking unit and damping unit remain in contact with the set line forces, the ink applicator rolls 10, 11, 14 and 15 roll on the forme cylinder 20 and retreat from the holding elements 91, 92, 93 and 94.

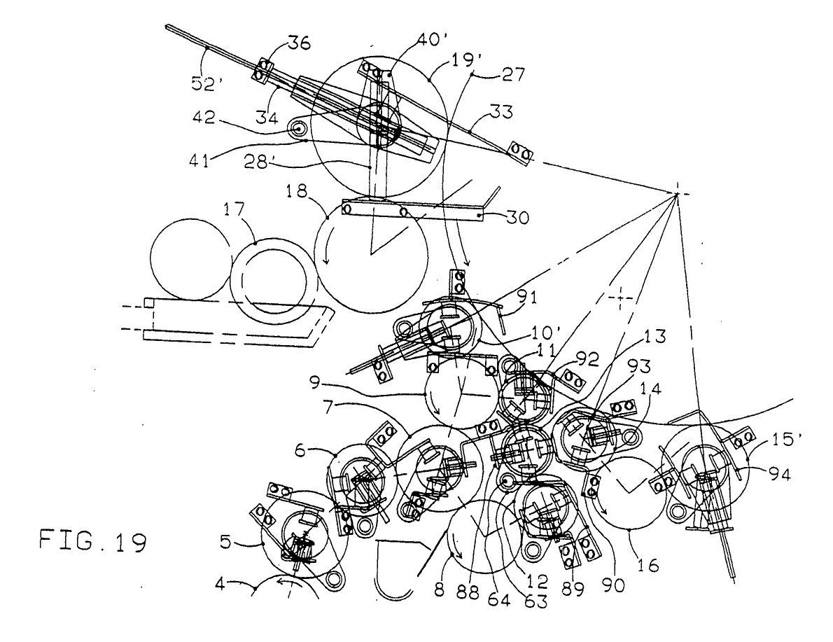

FIG. 19 shows the same operating state of the printing unit as FIG. 18 but a large-format press cylinder 27 is shown. The damping solution applicator roll 19 and the ink applicator rolls 10 and 15 have to retreat here as compared with the position illustrated in FIG. 18. However, the damping solution applicator roll 19 and the ink applicator rolls 10 and 15 always remain in contact with the adjacent rolls of damping unit and inking unit, respectively, with the set line force.

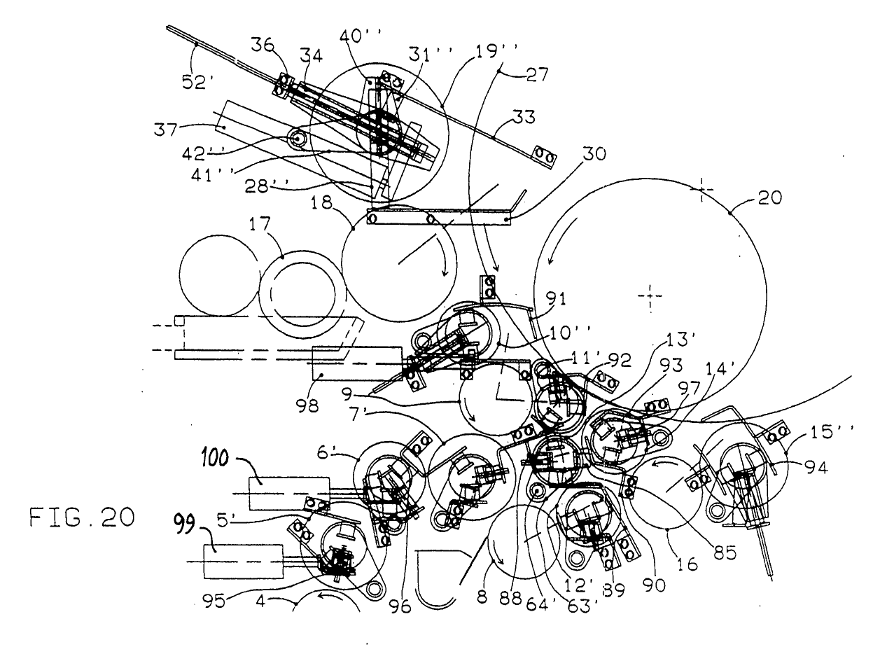

FIG. 20 shows the printing unit in a thrown-off position, in which the rolls of inking unit and damping unit do not touch one another. The rolls 7, 11, 12 and 15 of the inking unit reach the thrown-off positions 7′, 11′, 12′ and 15″ shown in FIG. 20 automatically under the influence of the force of gravity after the pneumatic air has been switched off. The inking unit roll 5 is pushed into the position shown by pneumatic piston 95, the roll 6 is pushed into the position shown by pneumatic piston 96, the roll 13 is pushed into the position shown by pneumatic piston 85, and the roll 14 is pushed into the position shown by pneumatic piston 97, the pneumatic pistons 95, 96 and 97 again being present in pairs. The ink applicator roll 10 is pushed by pneumatic cylinder 98 into the position identified by the reference number 10″; the damping solution applicator roll 19 is brought with the aid of the pneumatic cylinder 37 into the position shown by the reference number 19″, the cylinders 98 and 37 again being present in pairs. The positions of the ink applicator roll 10 and damping solution applicator roll 19, shown by the reference numbers 10″ and 19″, are storage positions in the side walls 38 of the printing unit. In the case of the inking unit rolls 5 and 6, on account of the direction of movement of the same, stores are provided by means of specific storage cylinders 99 and 100 which, in the extended state, permit the storage of the respective rolls, so that no pneumatic air is needed for this position.

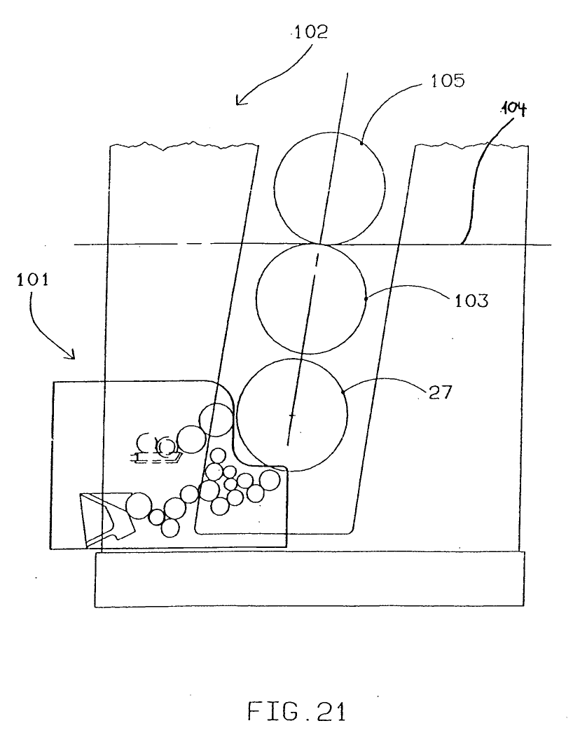

FIGS. 21 to 24 in each case show a detail from a press unit 102 comprising two printing units, the two printing units being used to print an upper side and an underside of a web-like printing material. Of the printing unit which is used for printing the underside of the printing material, an inking unit 101 comprising inking unit and damping unit, the forme cylinder 27 and a rubber-covered cylinder 103 are shown. Of the printing unit which is used for printing the upper side of the web-like printing material 104, only a rubber-covered cylinder 105 is shown.

In FIGS. 21 to 24, the cylinder 105 can also be an impression cylinder, as it is known, the press unit 102 then comprising only one printing unit.

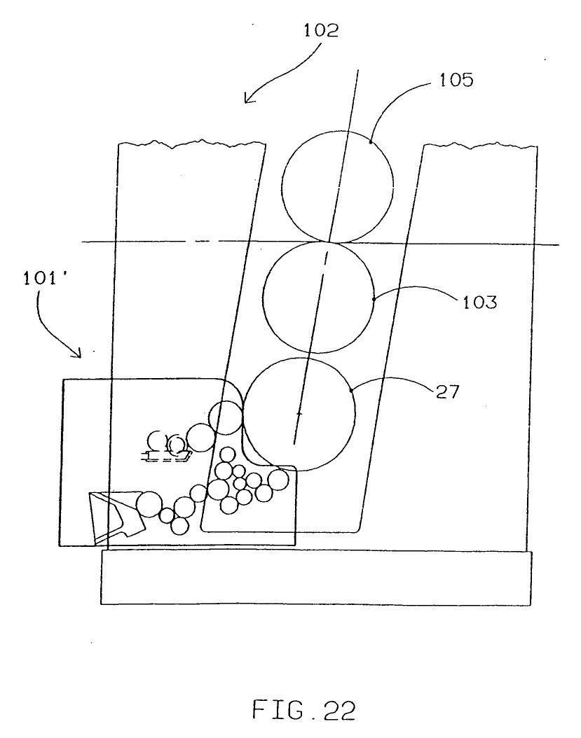

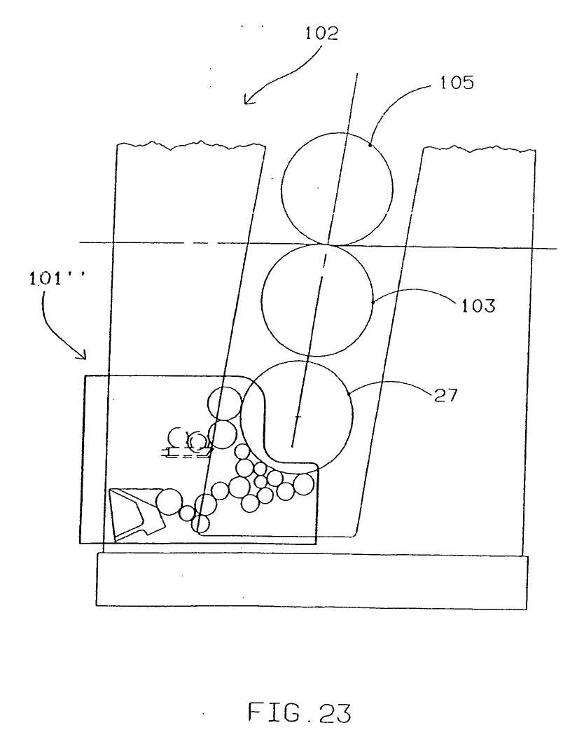

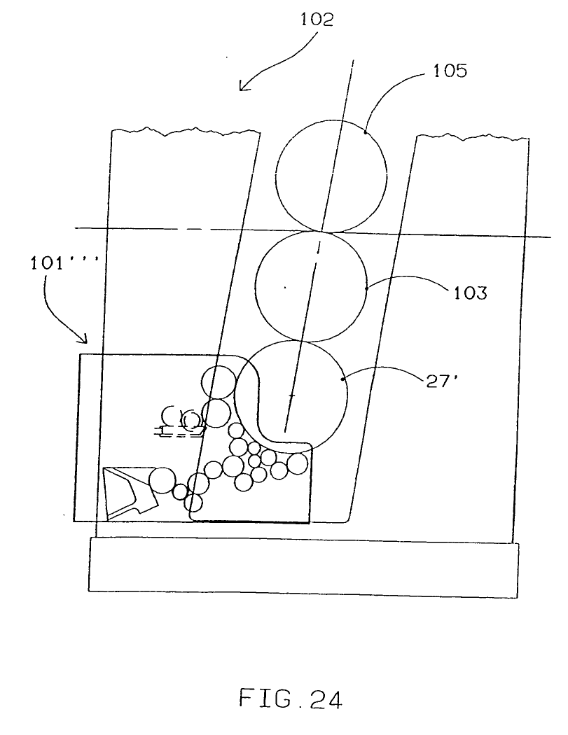

In FIG. 21, the inking unit 101 is in a position as shown in FIG. 16. The inking unit rolls of the inking unit are being pre-inked, the damping unit roll of the damping unit is being pre-damped. None of the rolls of inking unit or damping unit touches the forme cylinder 27, which in turn has been thrown off the rubber-covered cylinder 103. In the position 101′ of the inking unit 101 shown in FIG. 22, the damping solution applicator roll of the damping unit is resting on the forme cylinder 27 and accordingly effecting pre-damping of the or each printing forme positioned on the forme cylinder 27. FIG. 22 therefore corresponds to FIG. 17. In FIG. 22, the ink applicator rolls of the inking unit have been thrown off the forme cylinder 27. Likewise, the forme cylinder 27 has been thrown off the rubber-covered cylinder 103. In the position 101″ of the inking unit illustrated in FIG. 23, the damping solution applicator roll of the damping unit and the ink applicator rolls of the inking unit have been thrown onto the forme cylinder 27. Here, printing ink and damping solution are then applied to the or each printing forme positioned on the forme cylinder 27. The forme cylinder 27 is still thrown off the rubber-covered cylinder 103. In FIG. 24, the inking unit 101 thrown onto the forme cylinder 27, together with the forme cylinder 27, has been displaced into a printing position in which the press cylinder 27 assumes the position 27′ and rolls on the rubber-covered cylinder 103. FIG. 24 accordingly shows the press unit in a printing position for printing the web-like printing material 104. During the printing of the printing material 104, the rubber-covered cylinders 103 and 105 rotate at the same circumferential speed.

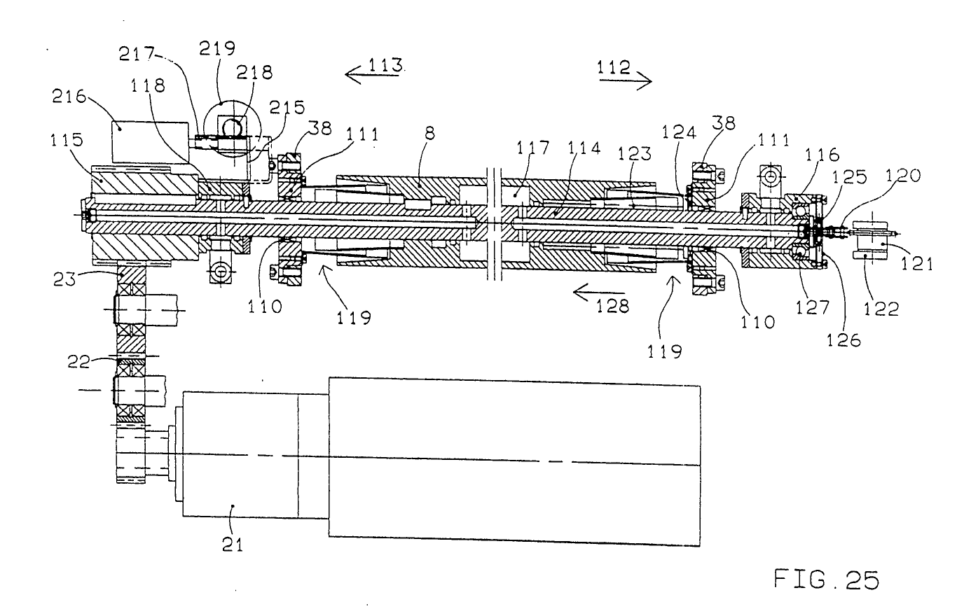

FIG. 25 shows a cross section through the distributor roll 8 of the inking unit of FIG. 1, this distributor roll being non-displaceable in its position but movable in its axial position. The fixed-location and axially movable mounting of the distributor roll 8 is carried out via bearings 110 within the side walls 38 of the inking unit according to the invention. The bearings 110 are positioned in bearing bushes 111 whose centering diameter is greater than the diameter of the distributor roll, so that a lateral removal of the distributor roll type in the direction of the direction arrows 112 and 113 is easily possible.

As already described with reference to FIG. 1, the distributor roll 8 is driven by the motor 21 via spur gears 22, 23. Seated on an axle 114 of the distributor roll 8 is a spur gear 115 which has a width to accommodate the reciprocating movement of the distributor roll in the direction of the direction arrows 112 and 113 and, accordingly, what is known as the oscillating movement of the distributor roll 8.

Via a rotary leadthrough 116, a temperature control medium, in particular controlled-temperature water, is led via bores in the axle 114 into an internal cavity 117 in the distributor roll 8 and, via appropriate bores, is led away out of the distributor roll 8 again via a rotary leadthrough 118. Labyrinth seals 119, which permit the axial movement of the distributor roll 8, in this case protect the bearings 110 against contaminants. The axial movement of the distributor roll 8 is controlled by a roller chain 120 having a deflection over a chain wheel 121, which is supported via a holding element 122 on the side wall 38 of the inking unit. In this case, the roller chain 120 operates counter to a spring force provided by a spring element 123, the spring element 123 being formed as a compression spring. The compression spring is supported with one end on the distributor roll 8 and with another end on an axial bearing 124. The roller chain 120 is fixed by a pin 125 in a disc 126, which is in turn screwed to the rotary leadthrough 116 From the rotary leadthrough 116, the force is transmitted to the axle 114 of the distributor roll 8 via an inclined ball bearing 127. This type of introduction of the force of the oscillating movement into the distributor roll 8 ensures a single force direction in the direction of the direction arrow 128 and therefore, in a simple way, compensation for any transmission play, it being impossible for changeover play to occur at all. Instead of the roller chain 120, a cable or a linkage with a deflection lever can of course also be used.

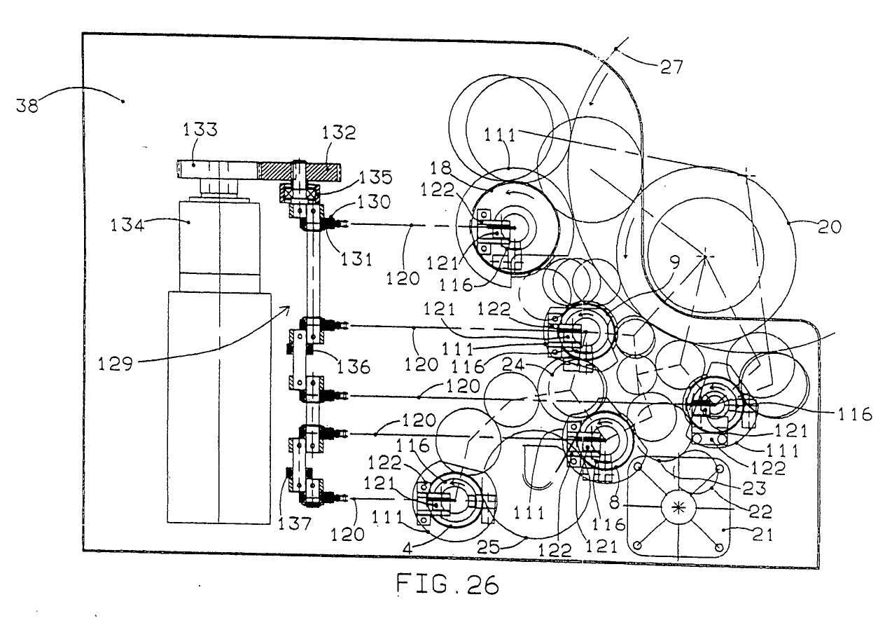

FIG. 26 shows the further configuration of the oscillating drive of the distributor roll 8. According to FIG. 26, the drive of the oscillating movement is carried out centrally via a crankshaft 129 for all the distributor rolls of the inking unit. The roller chains 120 are fixed by pins 130 to bearing housings 131. By means of an offset of the webs of the cranks, not illustrated, in terms of their angular position in relation to one another, it is possible to offset the strokes of the distributor rolls in relation to one another, specifically in such a way that reversal points of the strokes are offset in time or the stroke directions run oppositely. These settings are possible once during mounting. The crankshaft 129 is driven by a drive 134 via spur gears 132 and 133 and is fixed to the side walls 38 of the inking unit by bearings 135, 136 and 137.

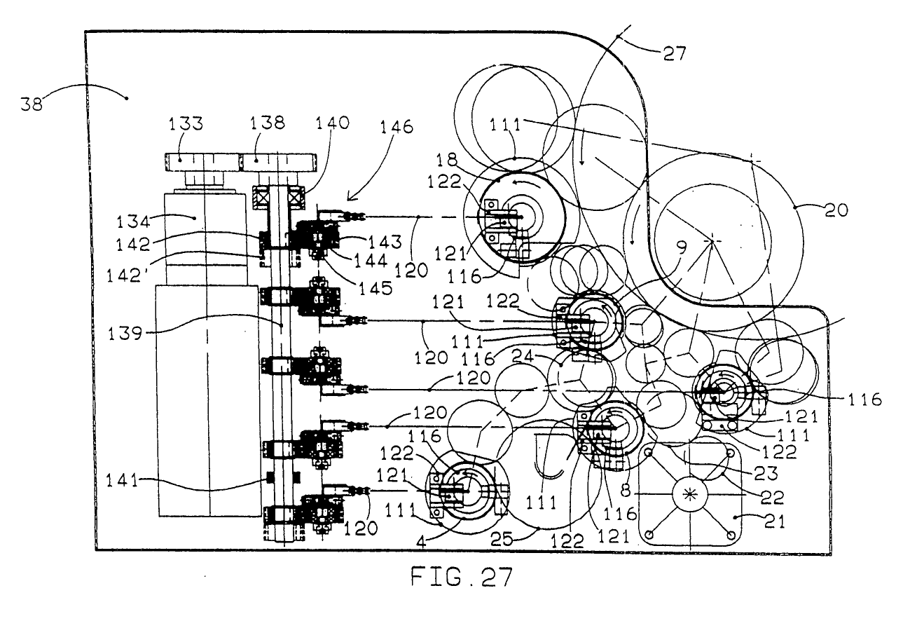

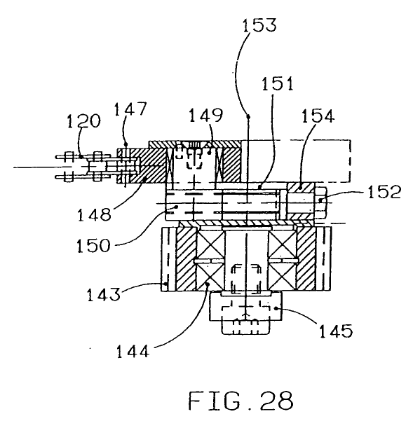

FIG. 27 shows a further refinement for the central oscillating drive of the distributor rolls, the drive 134 being coupled via spur gears 133 and 138 to a shaft 139, which is connected to the side wall 38 of the inking unit via bearings 140 and 141. Via spur gears 142, spur gears 143 are driven which are rotatably seated via bearings 144 on holding elements 145, which are likewise connected to the side wall 38 of the inking unit. Fixed to the spur gears 143 are adjustable crank drives 146, whose configuration will be described with reference to FIG. 28.

According to FIG. 28, the roller chain 120 is fixed via a pin 147 to a housing 148, the housing 148 being rotatably mounted on a pin 149 of a sliding block 150. The sliding block 150 can be displaced within a guide 151 which is screwed to the spur gear 143. An eccentric position of the pin 147 in relation to an axis of rotation 153 of the spur gear 143 can be varied via a setting screw 152. In this way, the stroke of the distributor roll can be set continuously and manually from the maximum value down to a minimum value. The setting screw 152 can be fixed via a clamping piece 154. The reciprocating position of the distributor roll may be varied by the spur gear 142 being displaced into the position identified by the reference number 142′ and therefore being brought out of engagement with the spur gear 143. The spur gear 143 is then rotated and the spur gear 142 is then brought into engagement.

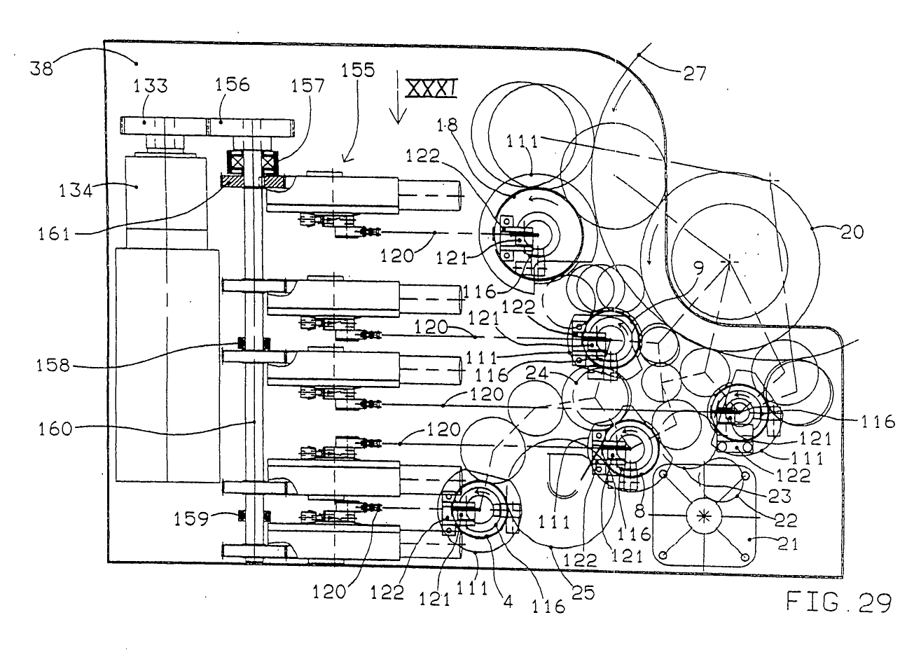

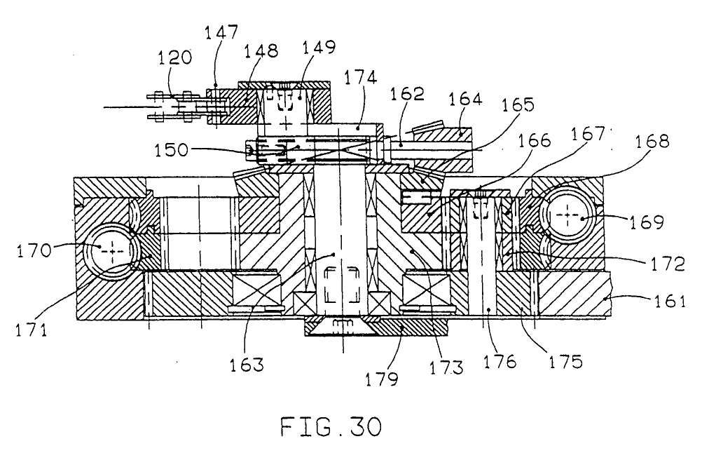

FIG. 29 shows a configuration of the central drive for the distributor rolls which is implemented via epicyclic gear mechanisms 155. The central drive 134 drives via spur gears 133, 156 into the shaft 160 mounted in bearings 157, 158 and 159, to which shaft there are fixed spur gears 161 which drive into the epicyclic gear mechanisms 155. The function of the epicyclic gear mechanism 155 will be described below with reference to FIG. 30.

In the exemplary embodiment of FIG. 30, the roller chain 120 is fixed in the manner analogous to the exemplary embodiment of FIG. 28, for which reason the same reference numbers are used for the same components. The roller chain 120 is fixed by the pin 147 to the housing 148 which is rotatably mounted on the pin 149 of the sliding block 150. The sliding block 150 can be displaced via a threaded spindle 162, so that the eccentric position of the pin 149 in relation to the axis of rotation 163 changes. A bevel gear 164 is fixed on the spindle 162 and may be moved via a bevel gear 165, via the spur gear 166, via the planet wheel 167 and the internally toothed wheel 168 with the aid of a worm drive 169. Via a second worm drive 170, the spur gear 173, on which a guide 174 is screwed, may be rotated via the internally toothed wheel 171 and the planet wheel 172. In this way, the angular position of the eccentrically mounted pin 149 can be varied. In order to vary this angular position, the worm drives 169 and 170 have to be rotated jointly in the same direction, since otherwise a relative movement between the gears 166 and 173 results, which can cause possibly undesired rotation of the spindle 162. In order to rotate the threaded spindle 162 on its own, in turn only a rotation of the worm drive 162 is sufficient. The drive for the rotation of the eccentrically mounted pin 149 about the axis of rotation 163, and therefore for the reciprocating movement of the distributor roll, is transmitted via the spur gear 161 to a spur gear 175, by the planet set having the planet wheels 167 and 172 being mounted on pins 176, driving the gears 166 and 173 in the same direction and without any relative movement in relation to each other. While the drive for the distributor rolls is running, the stroke of the distributor roll can thus be adjusted continuously by moving the worm drive 169, while by means of a common rotation of both worm drives 167 and 170 in the same direction, the phase angle of the distributor roll can be varied continuously. Therefore, regulation of the phase angle of the distributor roll and of the stroke of the same during the running of the inking unit or printing unit is possible.

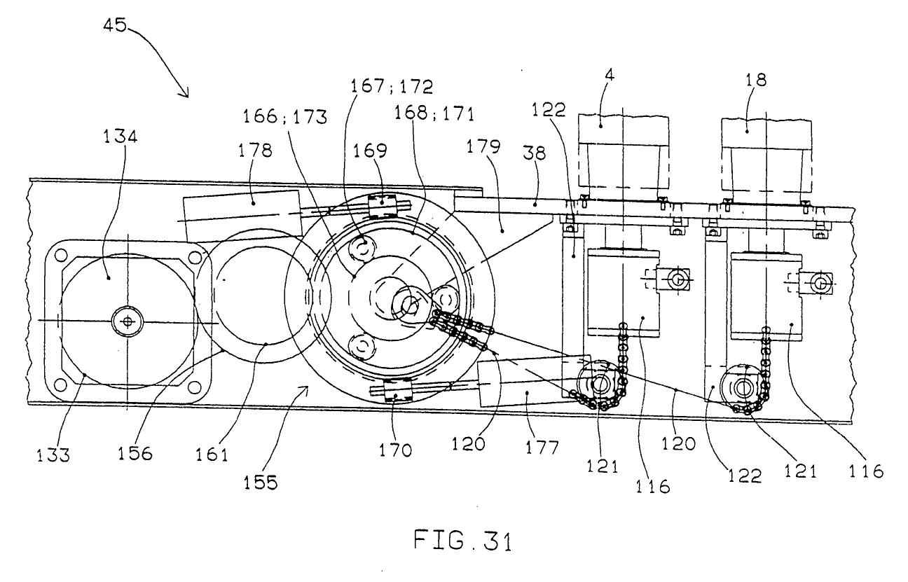

FIG. 31 shows in a plan view in the direction XI of FIG. 29, as an example of all the distributor rolls, the attachment of the distributor rolls 4 and 18 to the epicyclic gear mechanisms 155 with the aid of the roller chains 120 via a deflection around the chain wheels 121 mounted in the holding elements 122. Furthermore, geared motors 177 and 178 are shown, with the aid of which the worm drives 169 and 170 are rotated. The entire drive is accommodated in a protected manner within the housing 45, the epicyclic gear mechanisms being fixed to the side wall 38 of the inking unit by the axles 163 via holding elements 179.

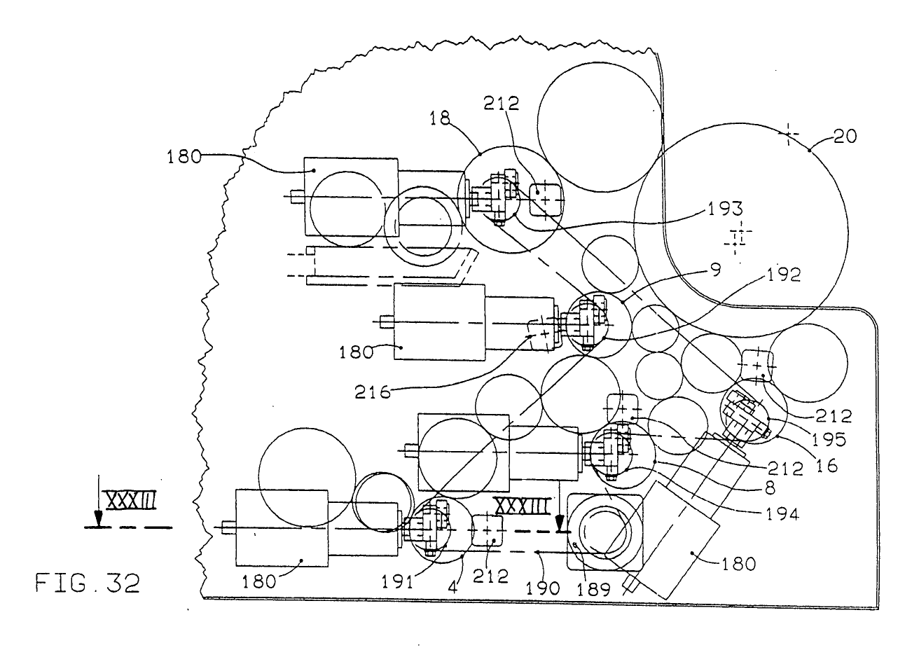

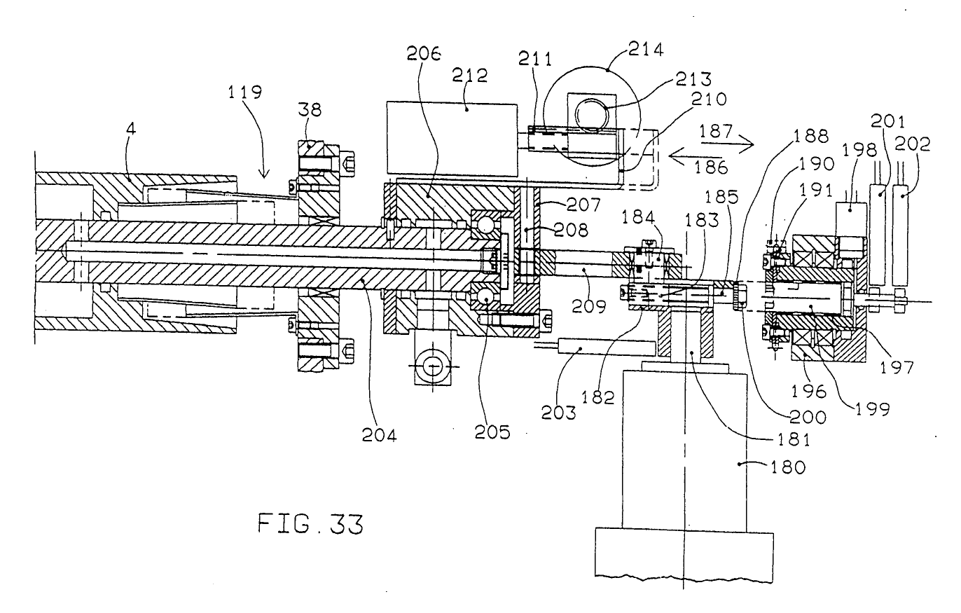

FIG. 32 and the section along the sectional direction XII-XII in FIG. 32, shown in FIG. 33, show another possible way of forming the oscillating drives, in which the oscillating drives for the distributor rolls 4, 8, 9, 16 and 18 are implemented individually via geared motors 180. Fixed to an axle 181 of the geared motors 180 are guides 182, which rotate about the axles 181. As already described in the other exemplary embodiments, sliding blocks 183 having pins 184 can be moved in the direction of the direction arrows 186 and 187 by threaded spindles 185. The threaded spindles are secured against automatic rotation via a latching safeguard 188. The eccentric position of the pin 184 in relation to the axle 181 can be varied continuously from a maximum value to a minimum value by rotating the threaded spindle 185 while the geared motor 180 is at a standstill. From a geared motor 189, an actuating movement is led centrally via a chain 190 to chain wheels 191, 192, 193, 194 and 195. These chain wheels 191 to 195 are mounted in holding elements 196 fixed to the side walls 38 of the inking unit. Counter to the force provided by a spring element 197, with the aid of compressed air which is supplied via a connection 198, a bolt 199 is displaced in the direction of the direction arrow 186 and, via a hexagon 200, is brought into engagement with the threaded spindle 185. The position of the bolt 199 is determined by sensors 201 and 202, the correct position of the guides 182 is monitored by a sensor 203 in order to initiate the actuating movement. The actuating movement can be initiated via the chain 190. An axle 204 of the distributor roll 4 is connected via a bearing 205 to a housing 206 and a disc 207, in which a pin 208 accommodates the mounting of a rod 209, which is mounted with its other end on the pin 184 and thus transmits the oscillating movement in the direction of the direction arrows 186 and 187.

FIG. 33 also shows that a holding element 210 is fixed to the housing 206. If an actuating movement is made on the threaded spindle 185 in the manner described above, then a rack 211 is forced against the holder 210 by a pneumatic cylinder 212. This rack 211 is connected via a pinion 213 to a potentiometer 214. In this way, in the position shown in FIG. 33, a measure of the eccentric position of the pin 184 in relation to the axle 181 of the drive 180 is determined. The remaining structure of the distributor roll 4 corresponds to the structure of the distributor roll 8 shown in FIG. 25. Of course, a compression spring 123 can also be used for the structure according to FIG. 33 in order to avoid any reversal of the direction of force.

If space is restricted, the measurement structure for determining the actuating value on the spindle 185 can also be transposed to the drive side of the distributor roll. Such a structure is shown by FIG. 25. Here, a holding element 215 is fixed to the rotary leadthrough 118. A pneumatic cylinder 216 displaces a rack. 217 against this holding element 215 during the measurement operation. The magnitude of the movement is picked up by a potentiometer 219 via a pinion 218.

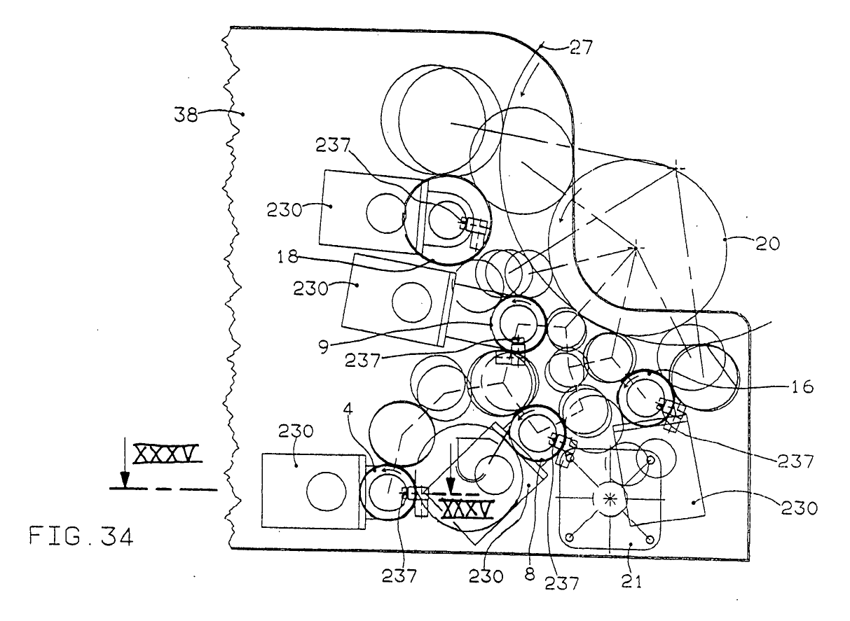

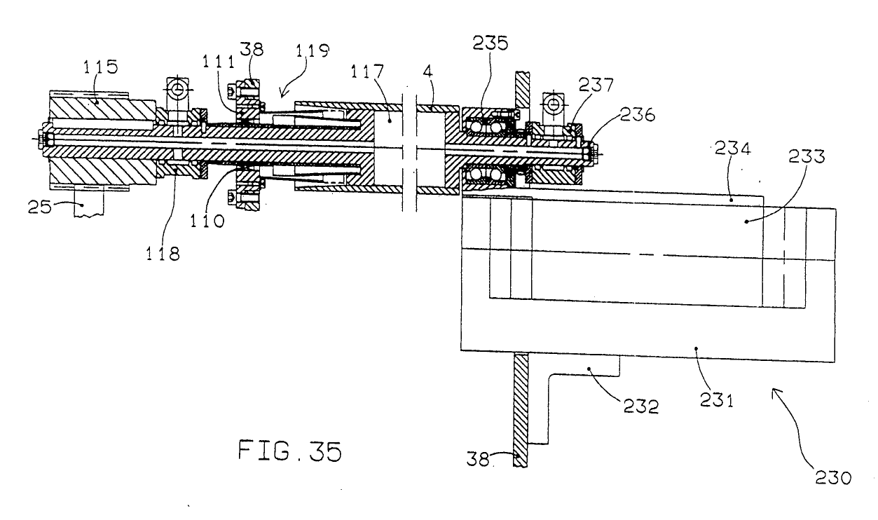

FIGS. 34 and 35 show a drive for the stroke of the distributor rolls which is implemented with the aid of a linear motor 230. The configuration of the mounting on the drive side of the distributor roll corresponds to the mounting according to FIG. 25, for which reason the same reference numbers are used for the same components. A rotor 231 of the linear motor 230 is fixed to the side wall 38 of the inking unit by a holding element 232. An axle 236 of the distributor roll 4 is mounted on a stator 233 of the linear motor 230 with the aid of a bearing plate 234 and a bearing 235. The bearing 235 is prestressed without play. A rotary leadthrough 237 leads a temperature control medium into the interior 117 of the distributor roll 4.

This arrangement with a linear motor 230 for controlling the stroke of the distributor rolls permits highly dynamic adaptation of the printing unit or inking unit to the requirements of the print.

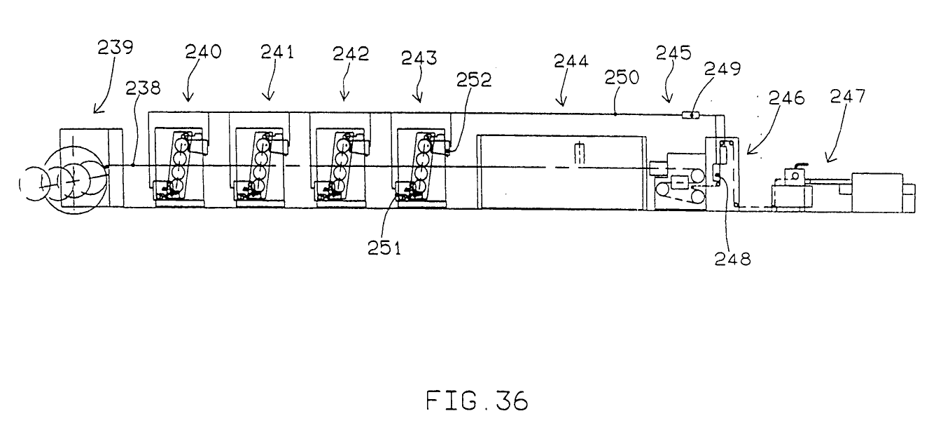

A control structure on a press for the purpose of inking unit regulation is illustrated schematically in FIG. 36. A printing material 238 to be printed is drawn off a roll changer 239 and printed on both sides in press units 240, 241, 242 and 243, which each comprise two printing units. Drying of the printed printing material is carried out in a dryer 244 and a cooling unit 245, the printing material subsequently being moved through an observation station 246 and supplied to a further processing station 247. In the observation station 246, the printed printing material web is scanned on both sides with the aid of cameras 248. The measured values are forwarded to a computer 249, which compares actual values and desired values with one another. Then, for the purpose of correction, appropriate actuating values are forwarded to the inking units 251 and 252 of the printing units via control lines 250.

In the event of a format change, the rolls of the printing units according to the invention adapt automatically to the format change, line forces remaining unchanged. If the line forces are to be changed then, as described above, they can be preset via a central restrictor. The magnitude of the distributor strokes of the distributor rolls, the phase angle of the distributor strokes and the rotational speed of the distributor rolls can likewise be adapted to the format size. All the values can be changed during the running of the press or printing units, in order always to guarantee an optimal printing result.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A printing unit for a web-fed rotary press, comprising:
a forme cylinder arranged and dimensioned for receiving at least one printing forme;
an inking unit arranged and dimensioned for applying printing ink to the at least one printing forme on said forme cylinder, said inking unit comprising inking unit rolls including ink applicator rolls and distributor rolls; and
a displacement mechanism arranged and dimensioned for automatically displacing at least some of said inking unit rolls during a format change in which said inking unit is adapted to a changing diameter of said forme cylinder, said displacement mechanism being arranged and dimensioned so that contacts between said inking unit rolls are maintained and constant line forces between said inking unit rolls are approximately maintained during the automatic displacing.

2. The printing unit of claim 1, wherein said inking unit rolls comprise first ones of the inking unit rolls and second ones of said inking unit rolls, said second ones of said inking unit rolls arranged and dimensioned for effecting an oscillating movement along respective rotational axes of said second ones of said inking unit rolls, said displacement mechanism being arranged and dimensioned to displace a relative position of said first ones of said inking unit rolls such that rotational axes of said first ones of said inking rolls are displaced, and said rotational axes of said second ones of said inking unit rolls being fixed in their relative position, said second ones of said inking unit rolls consisting of at least some of said distributor rolls of said inking unit.

3. The printing unit of claim 1, further comprising a damping unit arranged and dimensioned for applying a damping solution to said at least one printing forme on said forme cylinder, said damping unit comprising damping unit rolls including damping solution applicator rolls and distributor rolls, said damping unit rolls comprise first ones of the damping unit rolls and second ones of said damping unit rolls, said second ones of said damping unit rolls arranged and dimensioned for effecting an oscillating movement along respective rotational axes of said second ones of said damping unit rolls, said displacement mechanism being arranged and dimensioned to displace a relative position of said first ones of said damping unit rolls such that rotational axes of said first ones of said damping rolls are displaced, and said rotational axes of said second ones of said damping unit rolls being fixed in their relative position, said second ones of said damping unit rolls consisting of at least some of said distributor rolls of said damping unit.

4. The printing unit of claim 3, wherein each of said first ones of said damping unit rolls that can be displaced in its relative position includes a plurality of pneumatic pistons comprising a first pneumatic piston absorbing the weight of said each of said first ones of said damping units rolls, a second pneumatic piston providing a defined line force between said each of said first ones of said damping unit rolls and at least one of said distributor rolls of said damping unit, and a third pneumatic piston providing a defined line force between said each of said first ones of said damping unit rolls and said forme cylinder.

5. The printing unit claim 4, further comprising pneumatic cylinders, each of said pneumatic cylinders being assigned to one of said each of said first ones of said damping rolls, each of said pneumatic cylinders being arranged and dimensioned for moving a corresponding one of said each of said first ones of said damping rolls to a thrown-off position when said plurality of pneumatic pistons of said each of said first ones of said damping rolls are deactivated.

6. The printing unit of claim 4, wherein each of said plurality of pneumatic pistons is arranged and dimensioned such that a quantity of the pneumatic air supplied to said each of said plurality of pneumatic pistons is settable so that a constant force is produced on said each of said plurality of pneumatic pistons over an entire stroke of said each of said plurality of pneumatic pistons, said each of said plurality of pneumatic pistons being mounted as an air pad, whereby said each of said plurality of pneumatic pistons exhibits minimal friction.

7. The printing unit of claim 2, wherein each of said first ones of said inking unit rolls that can be displaced in its relative position includes a plurality of pneumatic pistons comprising a first pneumatic piston absorbing the weight of said each of said first ones of said inking unit rolls, a second pneumatic piston providing a defined line force between said each of said first ones of said inking unit rolls and at least one of said distributor rolls of said inking unit, and a third pneumatic piston providing a defined line force between said each of said first ones of said inking unit rolls and said forme cylinder.

8. The printing unit claim 7, further comprising pneumatic cylinders, each of said pneumatic cylinders being assigned to one of said each of said first ones of said inking unit rolls, each of said pneumatic cylinders being arranged and dimensioned for moving a corresponding one of said each of said first ones of said inking unit rolls to a thrown-off position when said plurality of pneumatic pistons of said first ones of said inking unit rolls are deactivated.

9. The printing unit of claim 7, wherein each of said plurality of pneumatic pistons is arranged and dimensioned such that a quantity of the pneumatic air supplied to said each of said plurality of pneumatic pistons is settable so that a constant force is produced on said each of said plurality of pneumatic pistons over an entire stroke of said each of said plurality of pneumatic pistons, said each of said plurality of pneumatic pistons being mounted as an air pad, whereby said each of said plurality of pneumatic pistons exhibits minimal friction.

10. The printing unit of claim 2, further comprising a central drive with a shaft and roller chains, said central drive arranged and dimensioned for driving the oscillation of said second ones of said inking unit rolls.

11. The printing unit of claim 2, further comprising individual drives, wherein each of said individual drives is arranged and dimensioned for driving the oscillation of a respective one of said each of said second ones of said inking unit rolls.

12. The printing unit of claim 2, wherein a stroke of the oscillating movement of said each of said second ones of said inking unit rolls is individually adjustable.

13. The printing unit of claim 2, further comprising a damping unit arranged and dimensioned for applying a damping solution to said at least one printing forme on said forme cylinder, said damping unit comprising damping unit rolls including damping solution applicator rolls and distributor rolls, said damping unit rolls comprise first ones of the damping unit rolls and second ones of said damping unit rolls, said second ones of said damping unit rolls arranged and dimensioned for effecting an oscillating movement along respective rotational axes of said second ones of said damping unit rolls, said displacement mechanism being arranged and dimensioned to displace a relative position of first ones of said damping unit rolls such that rotational axes of said first ones of said damping rolls are displaced, and said rotational axes of said second ones of said damping unit rolls being fixed in their relative position, said second ones of said damping unit rolls consisting of at least some of said distributor rolls of said damping unit.

14. The printing unit of claim 13, further comprising a central drive with a shaft and roller chains, said central drive arranged and dimensioned for driving the oscillation of said second ones of said inking unit rolls and said second ones of said damping unit rolls.

15. The printing unit of claim 13, further comprising individual drives, wherein each of said individual drives is arranged and dimensioned for driving the oscillation of a respective one of said each of said second ones of said inking unit rolls and said each of said second ones of said damping unit rolls.

16. The printing unit of claim 13, wherein a stroke of the oscillating movement of said each of said second ones of said inking unit rolls and said each of said second ones of said damping unit rolls is individually adjustable.
